(19) United States
(12) Patent Application Publication
(10) Pub. No.: US 2003/0024549 A1
(43) Pub. Date: Feb. 6, 2003

(54) Bolt holder and method for holding and/or cleaning a bolt

(76) Inventor: Steve Miller, Chicago, IL (US)

Correspondence Address: PATENTS+TMS, A Professional Corporation, 1914 North Milwaukee Avenue, Chicago, IL, 60647, US

(21) Appl. No.: 09/923,900

(22) Filed: Aug. 6, 2001

(51) Int. Cl. B08B 1/00

(52) U.S. Cl. 134/6

(57) ABSTRACT

An apparatus and a method secures a bolt, particularly for cleaning of the bolt. The apparatus allows a user to securely and safely hold an object such that the object may be placed against a spinning or rotating abrasive surface for cleaning. The apparatus has an opening at one end which allows the insertion and removal of the object, such as a bolt. When held in place by a securing rod, the object may be placed against an abrasive without the object becoming dislodged. A shield covering the object may protect against harm to the user through accidental slippage or discharge of the object, such as a bolt, from the apparatus.

### BACKGROUND OF THE INVENTION

The present invention generally relates to an apparatus and a method for holding and/or cleaning a bolt. More specifically, the present invention relates to an apparatus and method for securing a bolt during cleaning of the bolt.

It is, of course, generally known to use bolts for many purposes. However, bolts frequently become dirty from rust, grease, dried on particles and the like. To re-use the bolt, the bolt may require cleaning so that the bolt may be implemented for its ordinary purpose. Wire wheels may be incorporated with a bench-top grinder to clean bolts free of rust, dirt or the like are often used to clean bolts. Of course, a brush with a handle or steel wool may also be used to manually clean the bolt. This process is, of course, laborious and time-consuming.

Typically, a person uses a bench-top grinder with a dirty bolt. The person may hold the bolt with his/her hands or use pliers to hold the bolt against the wire wheels as rust and sludge left behind by years of use are slowly erased from the bolt. It is common for a person, after cleaning a bolt with the bench-top grinder using wire wheels to develop stiff hands and raw skin covered with stinging, irritating metal filings.

Further, it is, of course, generally known to provide a device for securing an object while work is performed on the object. Such known devices include multiple clamps or jaws which secure the object on which work is being performed. These devices merely grasp the object by means of movable jaws and/or clasps. It is often difficult for the user of such a device to clean the object without the object becoming displaced from the securing apparatus. As a result, objects may become lost and/or become dislodged from the securing mechanism and often pose a threat to the user.

A need, therefore, exists for an apparatus and a method for securing and/or cleaning a bolt which allows for protection of a worker's hands while cleaning the bolt. The apparatus may be used with other tools, such as, for example, wire wheels incorporated with a bench-top grinder or with steel wool or wire brush.

### SUMMARY OF THE INVENTION

The present invention generally relates to an apparatus for securing a bolt and/or other object while work is performed on the bolt and/or other object. The present invention further provides a method for securing and/or cleaning a bolt or other like object.

To this end, in an embodiment of the present invention, an apparatus for holding a bolt is provided. The apparatus has a body having a length defined by walls between a first end and a second end. The apparatus has a hole in the first end of the body, prongs at the second end of the body, an opening in the walls of the body at the second end of the body and a securing rod. The securing rod has a first end and a second end wherein the securing rod extends within the body such that the first end of the securing rod extends through the hole in the first end of the body and the second end of the securing rod extends up to the prongs at the second end of the body.

In an embodiment, the apparatus has a spring within the body such that the spring may extend between the first end of the body to a distance from the second end of the body.

In an embodiment, the apparatus has a shield covering the opening on the second end of the body.

In an embodiment, the apparatus has a handle attached to the securing rod.

In an embodiment, the apparatus has a cap on the second end of the securing rod.

In an embodiment, the apparatus has a prong opening formed between the prongs at the second end of the body.

In an embodiment, the apparatus has nuts inside the body wherein the nuts are attached to the walls of the body.

In another embodiment of the present invention, a method for holding an object is provided. The method comprises the steps of: providing a body wherein the body has a length defined by walls between a first end and a second end wherein an opening is provided in the walls of the body; providing a securing rod that extends in the body wherein the securing rod has a first end and a second end; and securing the object in the opening of the body with the securing rod.

In an embodiment, the method further comprises the step of providing prongs at the second end of the body.

In an embodiment, the method further comprises the step of securing the object in the opening of the body with a spring.

In an embodiment, the method further comprises the steps of covering the opening of the body with a shield and locking the shield in a position that encloses the opening of the body.

In an embodiment, the method further comprises the step of securing the object in the opening of the body with a handle attached to the securing rod.

In an embodiment, the method further comprises the steps of applying a nut to the object, inverting the object and securing the inverted object in the opening of the body.

In an embodiment, the method further comprises the step of securing the object in the opening of the body with the securing rod and a washer.

In another embodiment, a method for cleaning a bolt is provided. The method comprises the steps of: providing a body wherein the body has a length defined by walls between a first end and a second end wherein an opening is provided in the walls of the body; providing a securing rod that extends in the body wherein the securing rod has a first end and a second end; securing the bolt in the opening of the body with the securing rod; and holding the body with the secured bolt against an abrasive such that the bolt contacts the abrasive.

In an embodiment, the method further comprises the step of securing the bolt in the opening of the body with a spring and a bar.

In an embodiment, the method further comprises the step of covering the opening of the body with a shield.

In an embodiment, the method further comprises the step of locking the shield in a position that encloses the opening of the body.

In an embodiment, the method further comprises the step of securing the object in the opening of the body with a handle attached to the securing rod.

It is, therefore, an advantage of the present invention to provide an apparatus and a method for securing and/or cleaning a bolt that prevents the loss of bolts from the pressure created by putting the bolt in contact with a moving abrasive surface, such as steel wool.

Another advantage of the present invention is to provide an apparatus and a method for securing and/or cleaning a bolt that allows for a safe environment.

A still further advantage of the present invention is to provide an apparatus and a method for securing and/or cleaning a bolt such that the interchanging of various size washers allows various size bolts to be cleaned by the same apparatus.

Another advantage of the present invention is to provide an apparatus and a method for securing and/or cleaning a bolt that is inexpensive.

Another advantage of the present invention is to provide an apparatus and a method for securing and/or cleaning a bolt that is easily portable.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of an embodiment of a bolt holding safety apparatus of the present invention.

FIG. 2 illustrates a cross-sectional view of the present invention taken generally along the line II-II of FIG. 1 in an embodiment of the present invention.

FIG. 3 illustrates an exploded side view of a bolt holding safety apparatus in an embodiment of the present invention.

FIG. 4 illustrates a side view of a safety shield on the bolt holding safety apparatus in an embodiment of the present invention.

FIG. 5 illustrates a side view of the bolt holding safety apparatus in an embodiment of the present invention.

### DETAILED DESCRIPTION OF THE PRESENTLY PREFERRED EMBODIMENTS

The present invention generally relates to an apparatus and a method for holding and/or cleaning a bolt. More specifically, the present invention relates to an apparatus and method for securing a bolt during cleaning of the bolt.

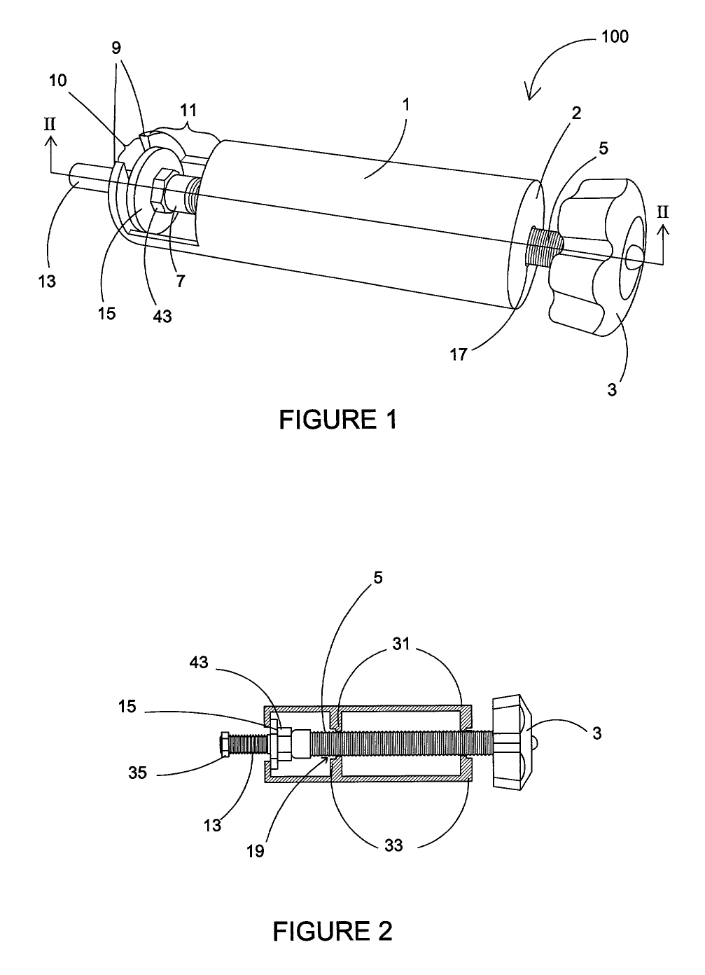

Referring now to the drawings wherein like numerals refer to like parts, FIGS. 1-3 generally illustrate an apparatus for securing a bolt into place while work is performed upon the bolt. The apparatus 100 may have a body 1 having a first end 2 and second end 4, a handle 3 and a securing rod 5. Preferably, the securing rod 5 is threaded.

The body 1 further includes an opening 11 wherein a bolt 13 may be inserted as generally illustrated in FIG. 1. The securing rod 5 may be inserted through a hole 17 at the first end 2 of the body 1. The body 1 may be threaded (not shown) at the first end 2 and the second end 4 to receive the securing rod 5. The securing rod 5 may exit through a hole 19 at the second end 4 of the body.

The body 1 may further have a prong opening 10 near the second end 4. The bolt 13 may be inserted into and removed from the prong opening 10. After the bolt 13 is inserted into the prong opening 10, the bolt 13 may be secured to the apparatus 100 by the securing rod 5. As shown in FIG. 1, the bolt 13 may be placed between prongs 9 and the bolt 13 may be secured by means of the securing rod 5.

As shown in FIG. 2, in an embodiment, the body 1 may be integrally formed with nuts 31 attached to inner walls 33 of the body 1. The nuts 31 may be threaded (not shown) so as to allow the securing rod 5 to be screwed down upon the bolt 13 such that the securing rod 5 applies pressure to the bolt 13 and the bolt 13 is tightly held between the securing rod 5 and the washer 15 and/or the prongs 9.

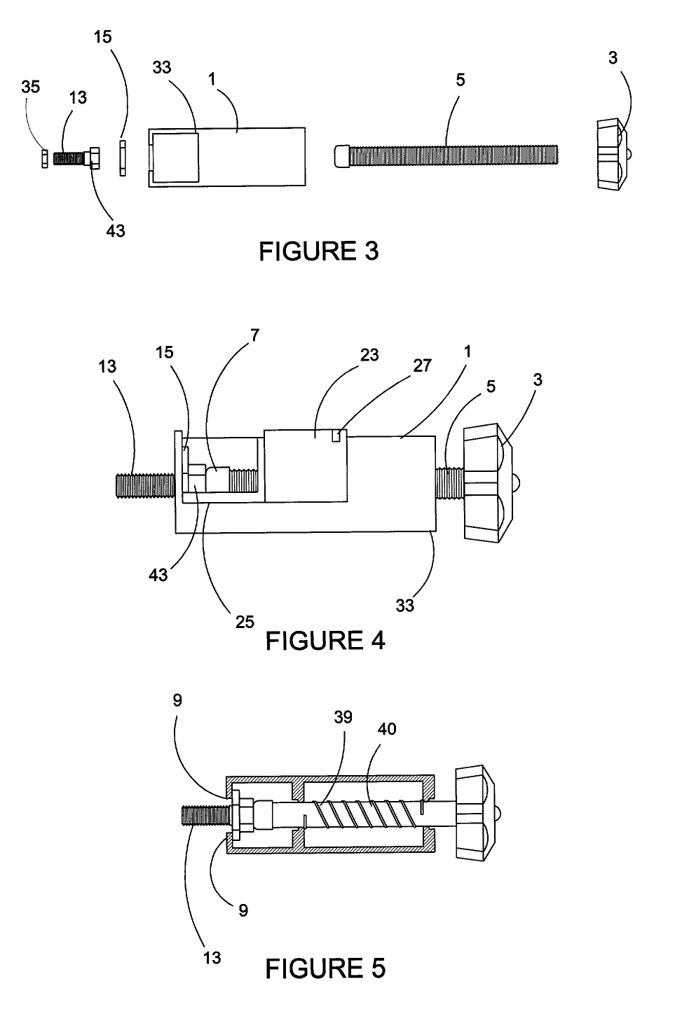

In the preferred embodiment, the apparatus may hold and/or secure a plurality of different sized bolts. As generally illustrated in FIG. 3, the bolt 13 may be so small that it may not fit between the prongs 9 of the apparatus 100 and may simply fall through the prongs 9 of the apparatus 100. As shown in FIG. 2, the bolt 13 may be inserted into a washer 15 and the washer 15 may be placed between the prongs 9 and a head 43 of the bolt 13 such that the washer 15 may keep the bolt 13 from falling through the prongs 9. The washer 15 and the bolt 13 may be placed inside the opening 11 of the apparatus 100 and the bolt 13 and the washer 15 may be securely held in place by means of the securing rod 5. In another embodiment, the prongs 9 may be designed and/or constructed as an adjustable clamping device such that the prongs 9 are movable to hold the bolt 13. To this end, the prongs 9 may be movable into a closed position to form an enclosed opening through which the bolt 13 may be inserted prior to closing the prongs 9.

The removable washer 15 may secure a bolt 13 without the need of using a smaller apparatus (not shown) or a smaller prong opening (not shown). Additionally, if the diameter (not shown) of the head 43 of the bolt 13 is greater than the size of the prong opening 10, the washer 15 may not be needed to secure the bolt 13 to the apparatus 100. The head 43 of the bolt 13 having a diameter greater than the prong opening 10, may be placed inside the opening 11 and against the prongs 9 and secured by the securing rod 5 without the aide of a washer 15. In an embodiment, a plurality of washers (not shown) of different sizes may be used to accommodate a plurality of bolts (not shown) of different sizes.

In an embodiment, a cap 7 may be removably attached to the securing rod 5. The cap 7 may prevent and/or may reduce scratching of the bolt 13 or scratching of the securing rod 5. To this end, the cap 7 may preserve the appearance of the bolt 13. Additionally, the cap 7 may provide a grip on the head 43 of the bolt 13 being secured and/or cleaned.

FIG. 4 generally illustrates, in an embodiment of the present invention, a safety shield 23. The safety shield 23 may provide a cover for the opening 11 of the apparatus 100. To this end, the shield 23 may prevent the bolt 13 from discharging from the apparatus 100. In addition, the safety shield may prevent loss of the bolt 13 as a result of the bolt 13 becoming dislodged from the apparatus 100.

Further, FIG. 4 illustrates tracks 25 on the body 1. The tracks 25 are sized to receive ends of the safety shield 23. As a result, the safety shield 23 may slide along a length of the body 1. In an embodiment, a notch 27 may be provided on the safety shield 23 which locks the safety shield 23 into place along the body 1 by means of an opposing indentation (not shown). Preferably, the safety shield 23 is locked in a position over the opening 11 such that the opening 11 is covered by the safety shield 23. The safety shield 23 may prevent the loss of the bolt 13 if the bolt 13, for example, becomes dislodged. Of course, other means for locking the safety shield 23 may be incorporated by those skilled in the art.

The safety shield 23 may be located in a position that allows for exposure of the opening 11 of the apparatus 100 as shown in FIG. 4. Alternatively, the safety shield 23 may be located in a position that allows for rotation around the circumference of the body 1 of the apparatus 100. The tracks 25, for the safety shield 23, may be perpendicular to the length of the body 1 of the apparatus 100. Use of the tracks 25 may accommodate engagement of the safety shield 23 prior to, and subsequent to, use of the apparatus 100.

FIG. 5 generally illustrates an alternate embodiment of the present invention wherein a spring 39 may be utilized inside the body 1 of the apparatus 100 to supply the force needed to secure the bolt 13 against the washer 15 and/or the prongs 9 of the body 1. The spring 39, in a relaxed position, may force a rod 40 against the bolt 13 to be secured and/or cleaned. In a compressed position, the spring 39 may allow the rod 40 to retract, and the pressure on bolt 13 may be released. When the spring 39 is in a compressed position, the bolt 13 may be removed or inserted into the apparatus 10.

In an alternate embodiment of the present invention, the bolt 13 may be inverted and then inserted into the opening 11 such that the head 43 of the bolt 13 is exposed for cleaning. A washer 15 may be placed between the nut 35 and the head 43 of the bolt 13. The washer 15 and the nut 35 may be used to keep the bolt 13 from falling through the prong opening 10. In an embodiment, the bolt 13 may be inserted into the apparatus 100 in an inverted position to allow for cleaning of the head 43 of the bolt 13.

It should be appreciated that the bolt 13 may be cleaned in various manners. Commonly, an abrasive is used to clean the bolt 13. The abrasive may be in the form of steel wool, a wire brush or a power driven wheel with an incorporated abrasive material. Of course, the abrasive may simply be a cloth or other like material that functions to clean and/or to remove debris or the like from the bolt 13, particularly between threads of the bolt 13.

It should be understood that various changes and modifications to the presently preferred embodiments described herein will be apparent to those skilled in the art. Such changes and modifications may be made without departing from the spirit and scope of the present invention and without diminishing its attendant advantages.

I claim:

1. An apparatus for holding a bolt, the apparatus comprising:
a body having a length defined by walls between a first end and a second end;
a hole in the first end of the body;
prongs at the second end of the body;
an opening in the walls of the body at the second end of the body; and
a securing rod having a first end and a second end wherein the securing rod extends within the body such that the first end of the securing rod extends through the hole in the first end of the body and the second end of the securing rod extends up to the prongs at the second end of the body.

2. The apparatus of claim 1 further comprising:
a spring within the body such that the spring may extend between the first end of the body to a distance from the second end of the body.

3. The apparatus of claim 1 further comprising:
a shield covering the opening on the second end of the body.

4. The apparatus of claim 1 further comprising:
a handle attached to the securing rod.

5. The apparatus of claim 1 further comprising:
a cap on the second end of the securing rod.

6. The apparatus of claim 1 further comprising:
a prong opening formed between the prongs at the second end of the body.

7. The apparatus of claim 1 further comprising:
nuts inside the body wherein the nuts are attached to the walls of the body.

8. A method for holding an object, the method comprising the steps of:
providing a body wherein the body has a length defined by walls between a first end and a second end wherein an opening is provided in the walls of the body;
providing a securing rod that extends in the body wherein the securing rod has a first end and a second end; and
securing the object in the opening of the body with the securing rod.

9. The method of claim 8 further comprising the step of:
providing prongs at the second end of the body.

10. The method of claim 8 further comprising the step of:
securing the object in the opening of the body with a spring.

11. The method of claim 8 further comprising the step of:
covering the opening of the body with a shield.

12. The method of claim 11 further comprising the step of:
locking the shield in a position that encloses the opening of the body.

13. The method of claim 8 further comprising the step of:
securing the object in the opening of the body with a handle attached to the securing rod.

14. The method of claim 8 further comprising the steps of:
applying a nut to the object;
inverting the object; and
securing the inverted object in the opening of the body.

15. The method of claim 8 further comprising the step of:
securing the object in the opening of the body with the securing rod and a washer.

16. A method for cleaning a bolt, the method comprising the steps of:
providing a body wherein the body has a length defined by walls between a first end and a second end wherein an opening is provided in the walls of the body;
providing a securing rod that extends in the body wherein the securing rod has a first end and a second end;
securing the bolt in the opening of the body with the securing rod; and
holding the body with the secured bolt against an abrasive such that the bolt contacts the abrasive.

17. The method of claim 16 further comprising the step of:
securing the bolt in the opening of the body with a spring and a bar.

18. The method of claim 16 further comprising the step of:
covering the opening of the body with a shield.

19. The method of claim 18 further comprising the step of:
locking the shield in a position that encloses the opening of the body.

20. The method of claim 16 further comprising the step of:
securing the object in the opening of the body with a handle attached to the securing rod.
